(19) United States
(12) Patent Application Publication
(10) Pub. No.: US 2006/0113236 A1
(43) Pub. Date: Jun. 1, 2006

(54) Breather filter

(76) Inventors: Andrew Dahlgren, Chanhassen, MN (US); Robert O. Nelson, Hastings, MN (US)

Correspondence Address: PAULY, DEVRIES SMITH & DEFFNER, L.L.C., 900 IDS CENTER, 80 SOUTH EIGHTH STREET, MINNEAPOLIS, MN, 55402-8773, US

(21) Appl. No.: 11/225,391

(22) Filed: Sep. 13, 2005

Related U.S. Application Data
(60) Provisional application No. 60/609,907, filed on Sep. 13, 2004.

(51) Int. Cl. B01D 29/00

(52) U.S. Cl. 210/237

(57) ABSTRACT

The present invention is directed to a filter for placement over a breather opening of an enclosure, such as a headlamp. The filter includes an elastomeric body having a primary channel extending from a first end to a second end of the elastomeric body, and a plurality of secondary channels extending from the first end to the second end of the elastomeric body. A cap is configured to at least partially cover the elastomeric body, the cap having an interior surface and an exterior surface. Filter material is arranged in fluid communication with the primary and secondary channels, the filter material configured to filter air flowing through the primary and secondary channels.

### REFERENCE TO PRIORITY APPLICATION

This application claims the benefit of Provisional Application No. 60/609,907, filed Sep. 13, 2004, which is incorporated by reference herein in its entirety.

### FIELD OF THE INVENTION

The present invention is directed to breather filters, including breather filters for use over the breather port of automobile headlamps.

### BACKGROUND OF THE INVENTION

Automobile headlamps are exposed to challenging environmental conditions that include grease, oil, dirt, dust, mud, and water. Historically, many automobile headlamp assemblies were entirely sealed, preventing the entry of various contaminants into the assembly. However, in recent years many headlamp designs have started to include breather holes that allow air to enter and exit the assembly. These designs are particularly common with more advanced light systems, such as those incorporating halogen bulbs that produce high temperatures. Breather holes are present on such headlamp assemblies to allow air pressure differentials to equalize between the interior and exterior of the assembly.

Although breather holes are important in many headlamp assemblies, they also pose problems by allowing contaminants to enter the assembly. Such contaminants can include, as described above, grease, oil, dust, and water. Water can be a particular problem, because it can condense on interior surfaces and create unsightly changes in the light pattern emanating from the lens.

Therefore, a need exists for a way to filter the air entering and leaving headlamp assemblies.

### SUMMARY OF THE INVENTION

The present invention is directed to an improved breather filter. In certain implementations the breather filter of the invention is particularly suited as a breather or vent filter for use in headlamps for the automotive industry. The filter of the present invention prevents contamination of the interior of the headlamp. In particular, the vent filter keeps out contaminants such as dirt grease, and liquid water, while allowing moisture to escape from the interior of the headlamp. Escape of such moisture can be quite important, since it prevents condensation from forming within the headlight, which can be unattractive as well as reduce the efficiency and illumination properties of the headlight.

Thus, the present invention is directed to a breather filter for placement over a breather opening in an enclosure, such as a headlight assembly. The breather filter helps prevent dirt and moisture from entering the enclosure, while allowing the movement of air into and out of the enclosure as temperature and pressure changes occur. The breather filter is particularly useful at keeping heavy condensation and liquid water from entering the enclosure, while allowing small amounts of water that may inadvertently collect within the enclosure (such as by condensation) to escape.

A first embodiment of the invention is directed to a breather filter for placement over a breather opening of an enclosure. The breather filter includes an elastomeric body having a first end, a second end, a perimeter surface, a primary channel extending from the first end to the second end of the elastomeric body, and a plurality of secondary channels extending from the first end to the second end of the elastomeric body. The breather also includes a cap configured to at least partially cover the elastomeric body, the cap having an interior surface and an exterior surface, plus filter material arranged in fluid communication with the primary and secondary channels, the filter material configured to filter air flowing through the primary and secondary channels.

Another implementation is directed to a breather filter for placement over a breather opening of an enclosure, the breather filter having a body with a first end, a second end, and a channel extending from the first to second ends. A cap optionally at least partially covers the body, the cap having an interior surface and an exterior surface. The filter has a filter media support, the filter media support positioned in proximity to the elastomeric body and cap. Filter media is secured to the filter media support, and is in fluid communication with the channel in the body. The body, cap, filter media support and filter media in combination substantially cover the breather opening in the enclosure so that all or essentially all fluid flow into and out of the breather opening is through the filter media.

A further implementation of the invention is directed to a breather filter for placement over a breather opening of an enclosure, the breather filter containing an exposed elastomeric body having a first end configured to cover a breather opening, a second end, a perimeter surface, and a primary channel extending from the first end to the second end of the elastomeric body. The filter includes an oleophobic filter material covering the second end of the exposed elastomeric body. Such filters are similar to those described above and elsewhere in this application, but generally do not include a cap and do not include secondary channels. Use of an oleophobic filter material, such as a PTFE material, allows the filter to be made without a cap.

Other features and advantages of the invention will be apparent from the following detailed description of the invention and the claims. The above summary of principles of the disclosure is not intended to describe each illustrated embodiment or every implementation of the present disclosure. The detailed description that follows more particularly exemplifies certain embodiments utilizing the principles disclosed herein.

### BRIEF DESCRIPTION OF THE DRAWINGS

The invention will be more fully explained with reference to the following drawings.

FIG. 1 shows a side elevational view of a breather filter made in accordance with a first implementation of the invention.

FIG. 2 shows a top elevational view of a breather filter made in accordance with a first implementation of the invention.

FIG. 3 shows a bottom elevational view of a breather filter made in accordance with a first implementation of the invention.

FIG. 4 shows an exploded view of the breather filter of FIG. 1.

FIG. 5 shows a perspective view of an elastomeric insert for a breather filter.

FIG. 6 shows a top elevational view of an elastomeric insert for the breather filter of FIG. 5.

FIG. 7 shows a cross sectional view of a headlight breather filter made in accordance with an implementation of the invention, showing directions of airflow through the assembly.

FIG. 8 shows a side cross sectional view of a headlight breather filter made in accordance with a further implementation of the invention.

FIG. 9 shows a side cross sectional view of a headlight breather filter made in accordance with a further implementation of the invention.

FIG. 10 shows a first piece of filter material for use in a headlight breather filter.

FIG. 11 shows a second piece of filter material for use in a headlight breather filter.

FIG. 12 shows a third piece of filter material for use in a headlight breather filter.

FIG. 13 shows a side cross sectional view of a headlight breather filter made in accordance with a further implementation of the invention.

FIGS. 14A, 14B, 14C and 14D show a breather filter in exploded view with the various components.

While principles of the invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure and claims.

### DETAILED DESCRIPTION OF THE PREFERRED EMBODIMENT

The present invention is directed to a filter for placement over a breather opening in an enclosure, such as a headlight assembly. The filter helps prevent dirt and moisture from entering the enclosure, while allowing the gradual flow of air into and out of the enclosure as temperature and pressure changes occur. These pressure changes often occur during weather changes or as the headlamp assembly heats up and cools off during use. The filter is particularly useful at keeping heavy condensation and liquid water from entering the enclosure, while allowing small amounts of water that may collect within the enclosure (such as by condensation) to escape in vapor form.

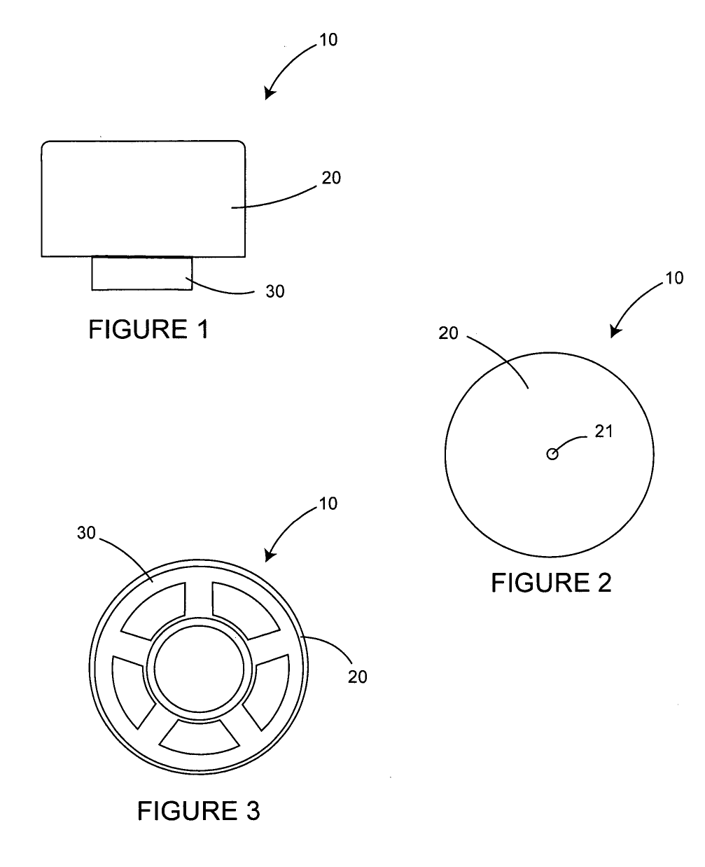

The invention will now be discussed in view of the drawings. FIG. 1 of the drawings shows a side elevational view of a breather filter 10 made in accordance with an example implementation of the invention. The breather filter includes a cap 20, along with an elastomeric insert 30, although only the lower portions of the elastomeric insert 30 are shown FIG. 1. FIG. 2 shows a top elevational view of the breather filter shown in FIG. 1, with only the cap 20 visible. The cap 20 in FIG. 2 is shown with a small opening 21. This small opening, which is used in certain embodiments of the invention but not others, allows moisture to drain away from the inside of the cap 20 when the filter 10 is installed on a headlamp in a direction where the cap is inverted relative to its orientation in FIG. 1. The opening 21 allows drops of moisture to flow out of the cap 20. However, as noted above, such openings are optional and not necessary for all implementations of the invention. FIG. 3 shows a bottom elevational view of the breather filter 10, showing the bottom side of the elastomeric insert 30 and the edge of the cap 20.

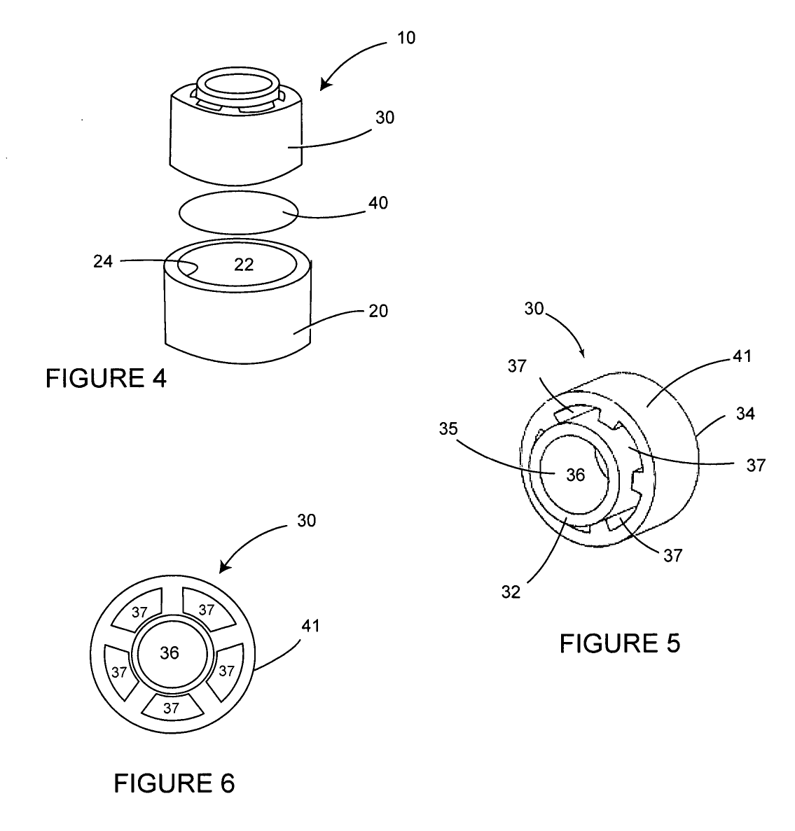

Referring now to FIG. 4, an exploded view of the breather filter 10 of FIG. 1 is provided. In this exploded view the elastomeric insert 30 is shown, along with the cap 20. A piece of filter material 40 is also depicted, the filter material 40 selected and positioned to prevent, or reduce, the flow of liquid water, dirt and grease, while allowing air and water vapor to pass across it. In this embodiment the filter material 40 is shown as a disk, and substantially covers an entire end of the elastomeric insert 30. However, as described below, the filter material 40 can be reduced in size so as to cover only a portion of the end of the elastomeric insert 30, and can be cut so as to have a central hole allowing it to be placed on the opposite end of the elastomeric insert 30.

Referring now to additional aspects of the elastomeric insert 30, reference is made to FIG. 5, which shows a perspective view of an elastomeric insert 30 for a breather filter 10; and FIG. 6, which shows a top elevational view of an elastomeric insert 30 for breather filter 10. The elastomeric insert 30 has a first end 32 and a second end 34, along with a perimeter surface 41.

The first and second ends 32, 34 can be substantially flat or can have irregular surface features. However, generally either the first or second end 32, 34 of the elastomeric insert 30 will be configured to receive a filter material 40 that is bonded to elastomeric insert 30, so one of these two ends 32, 34 typically has at least a planar area suitable for bonding of the filter material 40. The first end 32 of the elastomeric insert 30 includes a primary opening 35 leading to a primary channel 36 extending through the elastomeric insert 30. In certain implementations of the invention, primary opening 35 and primary channel 36 in the elastomeric insert 30 fit over a breather port or nipple on an enclosure.

Typically the primary opening 35 and primary channel 36 in the elastomeric insert 30 are sized so as to expand slightly upon fitting onto a breather port or nipple so that the filter assembly 10 is held in place by the compressive force of the elastomeric insert 30. In alternative embodiments the elastomeric insert 30 can be held in place by an adhesive material, mechanical retainer, or other means for securing the elastomeric insert 30 and filter assembly 10 to an enclosure.

The elastomeric insert 30 also contains a plurality of secondary openings 37, in this embodiment extending around the primary opening 35. It will be appreciated, however, that similar designs may be made w/o the use of these secondary openings. In such embodiments only a primary channel is typically present, and the filter does not contain a cap. The secondary openings also extend by way of channels through the elastomeric insert 30 from the first end 32 to the second end 34 of the insert 30. The elastomeric insert 30 has a perimeter surface 41 configured, in the embodiment shown, to snuggly fit within the interior 22 (see FIG. 4) of the cap 20 by compression fitting against the interior surface 24 of the cap 20. However, it will be appreciated that in alternative embodiments the perimeter surface 41 does not directly engage the interior surface 24 of the cap 20.

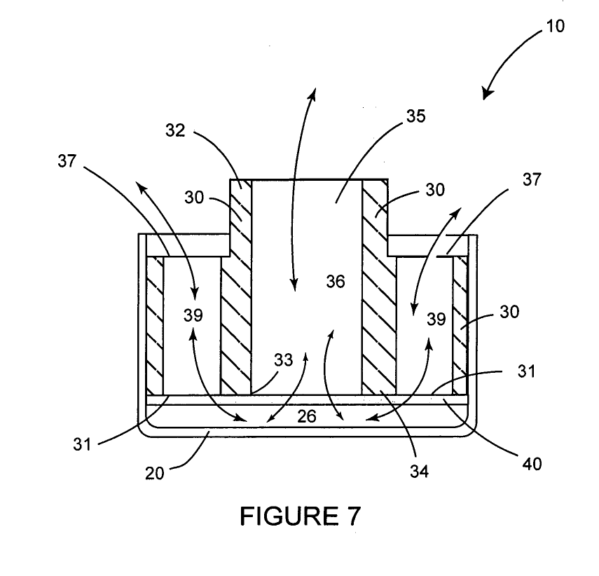

The flow of air into and out of the breather filter 10 is depicted in FIG. 7, which shows a cross sectional view of a breather filter made in accordance with an implementation of the invention. FIG. 7 also shows additional aspects of the elastomeric insert 30, including the second end 33 of the primary channel 36 extending through the elastomeric insert 30. Also, the secondary channels 39 are shown, extending from first openings 37 to second openings 31. Finally, the placement of the filter media 40 is depicted, with filter media 40 positioned over the second end 34 of the elastomeric insert 30.

In the embodiment depicted air can flow through the first openings 37 in the secondary channels 39 through the elastomeric insert 30, then through filter media 40, into an airspace 26 between the cap 20 and filter media 40, and then back through the media 40 and into the primary channel 36 that extends through the elastomeric insert 30. From the primary channel 36 the air can travel into the enclosure. It will also be noted that air flow can take the reverse direction, going from the interior of the enclosure, through the primary channel 36 and media 40, into air space 26, back through media 40, into one or more secondary channels 39, and then out of the filter 10.

In the embodiment shown in FIGS. 4 and 7 the filter media 40 is a disc positioned to cover the primary channel 36 as well as the secondary channels 39 at their interior openings (openings 31 and 33). However, it will be appreciated that in alternative embodiments the filter media 40 can be cut into a washer design with an open center so it covers only the openings 31 at the end of the secondary channels 39. An alternative embodiment for the filter media 40 can be a washer design with an open center that covers the first end 37 of the secondary channels 39, on the exterior of the filter 10. This embodiment is particularly useful in keeping water from getting trapped in the channel 39 or air space 26. In yet another implementation a smaller disc of filter media 40 is used, and this smaller disc covers only the interior opening 33 of the primary channel 36. Yet other embodiments can include a combination of these filter media to cover all or some of the openings in the channels through the elastomeric insert 30.

In one embodiment, each of the secondary channels 39 have a cross-sectional flow area less than the cross-sectional flow area of the primary channel 36. In another embodiment, the combined cross sectional flow area of all of the secondary channels 39 is equal to the cross sectional flow area of the primary channel 36.

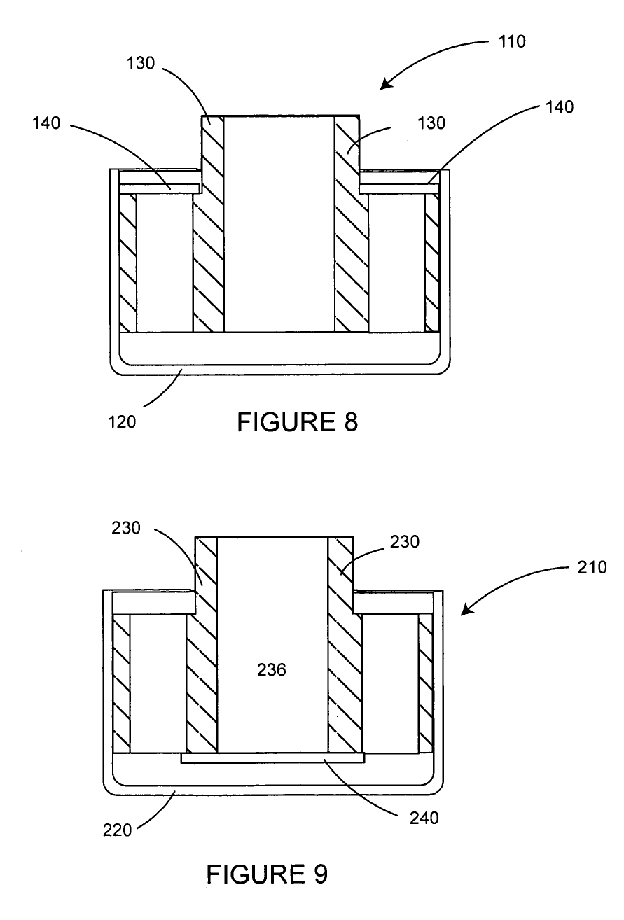

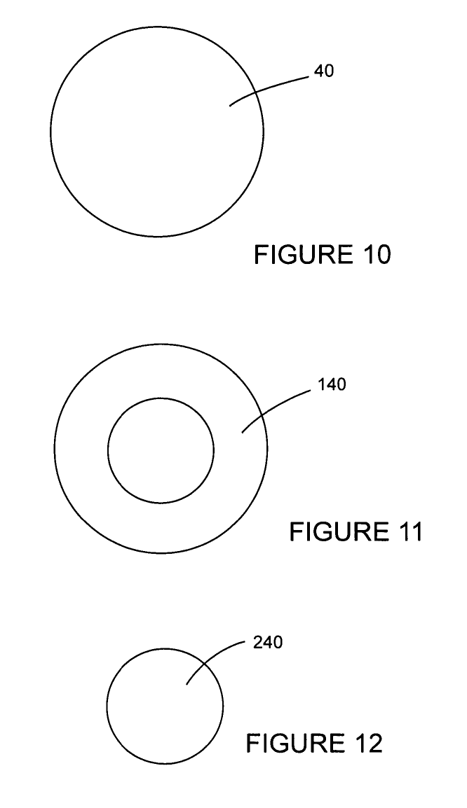

FIG. 8 shows a side cross sectional view of a breather filter 110 made in accordance with a further implementation of the invention, and containing a cap 120, an elastomeric insert 130, and filter media 140. In this embodiment the filter media 140 is positioned on the exterior surface of the elastomeric insert 130. FIG. 9 shows a side cross sectional view of a breather filter 210 made in accordance with a further implementation of the invention, and containing a cap 220, an elastomeric insert 230, and filter media 240. In this embodiment the filter media 240 is positioned on the interior surface of the elastomeric insert 230 so as to cover only the primary channel 236 of the elastomeric insert. FIG. 10 shows a first filter material 40 for use in a breather filter, FIG. 11 shows second filter material 140, and FIG. 12 shows third filter material 240.

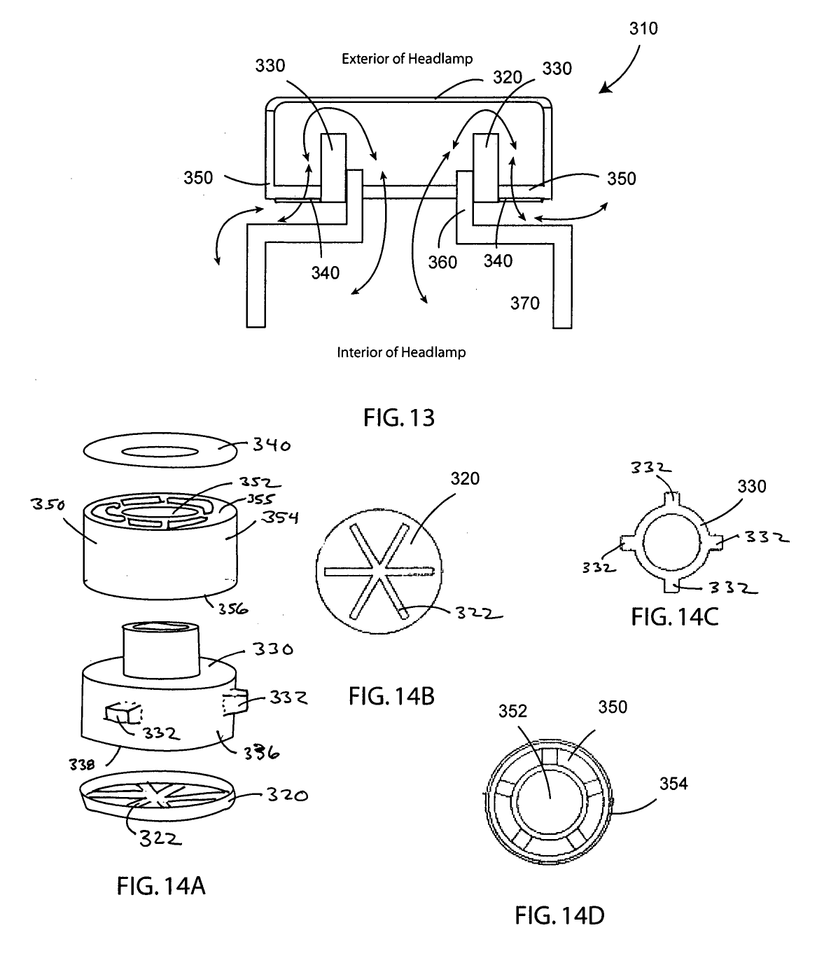

A further example embodiment of the invention is shown in FIGS. 13, 14A, 14B, 14C, and 14D. In FIG. 13 an example vent filter 310 is shown in cross sectional view, showing cap 320, insert 330, filter media 340, and body 350; all installed over a port 360 in an enclosure 370. FIGS. 14A to 14D show the vent filter in exploded view with the various components, including the cap 320, the elastomeric insert 330, and the body 350. The cap 320 is typically a molded plastic piece that provides water protection. The cap 320 is welded or otherwise secured to the edge 356 of the body 350. Cap 320 further includes raised interior ridges 332 (in the depicted embodiment), which elevates the bottom 338 of the elastomeric insert 330 from the cap 320, allowing air to flow between the cap 320 and the bottom 338 of the insert 330.

The insert 330 is typically a molded elastomeric piece formed with a central opening to adhere to a corresponding fitting on a headlamp assembly (such as by a friction fit). The body 350 typically comprises a molded plastic piece, such as a ring or washer, having an open interior 352 plus a perimeter 354. The filter media 340 is secured to this body 350 at top surface 355, and allows movement of air across the filter media 340. The filter media 340 is typically circular in shape, with an open interior, but other shapes are possible.

Protrusions 332 in the edges of the elastomeric insert 330 allow the elastomeric insert 330 to be placed within the body 354 such that the wall 336 of the elastomeric insert 330 is be kept away from the inner wall of the body 354, thereby allowing airflow between the body 354 and insert 330.

Suitable filter media for use with the present invention include polytetrafluoroethylene (PTFE) membranes. The filter media may also include one or more support layers, such as a support scrim, to support porous or microporous membranes. Examples of such support layers include woven and non-woven films made from, for example, stretched or sintered plastics, such as polyesters, polypropylene, polyethylene, and polyamides (e.g., nylon). In some embodiments, the support layer may be porous and permit substantial cross-flow of fluid across the support layer.

One exemplary filter media includes an expanded PTFE membrane and a porous, polymeric support scrim. The expanded PTFE membrane can be mounted to the elastomeric insert or body by media lamination adhesive, by heat, ultrasonics, pressure sensitive adhesive, epoxy, mechanical, or other means. The support scrim can be adhesively or thermally mounted on the expanded PTFE membrane. Other configurations of filter media can be formed using other combinations of layers. The filter media may be made to be resistant to oils by giving it an oleophobic treatment as described in U.S. Pat. Nos. 6,582,113 and 6,196,708, incorporated herein in their entirety.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. A breather filter for placement over a breather opening of an enclosure, the breather filter comprising:
a) an elastomeric body having:
a first end,
a second end,
a perimeter surface,
a primary channel extending from the first end to the second end of the elastomeric body, and
a plurality of secondary channels extending from the first end to the second end of the elastomeric body;
b) a cap configured to at least partially cover the elastomeric body, the cap having an interior surface and an exterior surface; and
c) filter material arranged in fluid communication with the primary and secondary channels, the filter material configured to filter air flowing through the primary and secondary channels.

2. The breather filter of claim 1, wherein the first end of the elastomeric body is configured to be secured to a breather port of the enclosure.

3. The breather filter of claim 1, wherein the filter material is secured to the elastomeric body such that it covers the plurality of secondary channels at the first end of the elastomeric body.

4. The breather filter of claim 1, wherein the filter material is secured to the elastomeric body such that it covers the plurality of secondary channels at the second end of the elastomeric body.

5. The breather filter of claim 1, wherein the filter material is secured to the elastomeric body such that it covers the plurality of secondary channels and covers the primary channel at the second end of the elastomeric body.

6. The breather filter of claim 1, wherein the filter material is secured to the second end of the elastomeric body such that it covers the primary channel at the second end of the elastomeric body.

7. The breather filter of claim 1, wherein the perimeter surface of the elastomeric body is configured to contact the interior surface of the cap.

8. The breather filter of claim 1, wherein the perimeter surface of the elastomeric body is configured to contact the interior surface of the cap and form a seal between the perimeter surface of the elastomeric body and the interior surface of the cap.

9. The breather filter of claim 1, wherein each of the secondary channels have a cross sectional flow area less than the cross sectional flow area of the primary channel.

10. The breather filter of claim 1, wherein the secondary channels have a combined cross sectional flow area equal to that of the primary channel.

11. The breather filter of claim 1, wherein the elastomeric body contains at least two secondary channels.

12. The breather filter of claim 1, wherein the elastomeric body contains at least three secondary channels.

13. The breather filter of claim 1, wherein the cap contains a breather hole.

14. The breather filter of claim 1, wherein the filter material comprises expanded polytetrafluoroethylene.

15. The breather filter of claim 1, wherein the filter material comprises an oleophobic treated polytetrafluoroethylene.

16. A breather filter for placement over a breather opening of an enclosure, the breather filter comprising:
a) an exposed elastomeric body having:
a first end configured to cover a breather opening, a second end, a perimeter surface, and a primary channel extending from the first end to the second end of the elastomeric body, and
b) an oleophobic filter material covering the second end of the exposed elastomeric body.

17. The breather filter of claim 16, wherein the oleophobic filter material comprises polytetrafluoroethylene.

18. A breather filter for placement over a breather opening of an enclosure, the breather filter comprising:
a) a body having a first end, a second end, and a channel from the first to second ends;
b) a cap configured to at least partially cover the body, the cap having an interior surface and an exterior surface;
c) a filter media support, the filter media support positioned in proximity to the elastomeric body and cap; and
d) filter media secured to the filter media support, the filter media in fluid communication with the channel in the body;
wherein the body, cap, filter media support and filter media are configured to substantially cover the breather opening in the enclosure so that all or essentially all fluid flow into and out of the breather opening is through the filter media.

19. The breather filter of claim 18, wherein the filter media comprises a polytetrafluoroethylene membrane.

20. The breather filter of claim 18, wherein the body comprises an elastomeric material.
